(19) United States
(12) Patent Application Publication
(10) Pub. No.: US 2017/0011331 A1
(43) Pub. Date: Jan. 12, 2017

(54) Guest Interface For Generating Work Order in a Work Order Management System

(71) Applicant: Quore Systems, LLC, Franklin, TN (US)

(72) Inventor: Robert Scott Schaedle, Franklin, TN (US)

(21) Appl. No.: 15/273,701

(22) Filed: Sep. 23, 2016

Related U.S. Application Data
(63) Continuation-in-part of application No. 14/185,901, filed on Feb. 20, 2014.
(60) Provisional application No. 62/222,437, filed on Sep. 23, 2015.

(51) Int. Cl. G06Q 10/06; H04W 4/04; H04L 29/08

(52) U.S. Cl. CPC G06Q 10/063114; H04L 67/306; H04W 4/04; H04L 67/12; H04L 67/42

(57) ABSTRACT

A guest request management system enables hotel guests to directly enter work orders into a hotel's work order management system. In order to prevent the work order management system from being overwhelmed with illegitimate work orders, the guest request management system may be limited to registered guests at a given hotel during their stay at the hotel. Further, certain guest initiated requests (e.g., sundry delivery, towel service, etc.) should be limited to the room assigned to the guest placing the order (i.e., entering the work order into the work order management system of the hotel).

### CROSS-REFERENCES TO RELATED APPLICATIONS

This application is a non-provisional of and claims priority to U.S. Provisional Patent Application Ser. No. 62/222,437 filed Sep. 23, 2015 entitled GUEST INTERFACE FOR GENERATING WORK ORDER IN A WORK ORDER MANAGEMENT SYSTEM, and is a continuation-in-part of and claims priority to co-pending U.S. patent application Ser. No. 14/185,901 entitled “FACILITIES WORK ORDER MANAGEMENT SYSTEM AND METHODS” filed on Feb. 20, 2014, both of which are herein incorporated by reference in their entirety.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND

The present invention relates generally to guest request management systems in hotel networks. More particularly, this invention pertains to expanding a work order management system to accommodate guest requests.

Work orders are used to request and document work (e.g., repairs) performed on a facility (e.g., a building and its surrounding grounds). In the context of a hotel, workers at the front desk, workers in engineering (i.e., maintenance), or workers in housekeeping may notice or be informed by a guest of a condition on the property (i.e., facility) requiring maintenance. However, guests often see issues with a hotel but do not track down a worker or go to the front desk to report the issues. Instead, guests often just note the issues later on websites that collect hotel reviews. When guests are able to report hotel issues without tracking down hotel workers or going to the front desk, they are more likely to report those issues and allow the hotel to avoid negative online ratings.

Guests often avoid asking hotel workers or staff for towels, toiletries, or other sundries and services because they do not want to call the front desk or seek out a hotel worker. If guests are able to request these items and services without tracking down hotel workers or going to the front desk, they are more likely to report those issues and allow the hotel to avoid negative online ratings. These types of negative experience and negative online reviews are especially avoidable and especially damaging to luxury class hotels. Such hotels have the inventory and staff on hand to provide a positive experience if the guest notifies the hotel staff of the guest's needs, and negative reviews of this nature (i.e., failure in amenities or services) are especially damaging for these higher priced luxury based hotels.

### BRIEF SUMMARY

Aspects of the present invention provide a guest client configured to confirm a guest reservation with a hotel and the presence of the guest at the hotel. The guest client is further configured to directly enter work orders into a work order management system of the hotel.

In one aspect, a guest request management system includes a guest client having a user interface. The guest client is configured to receive guest credentials from a guest via the user interface. The guest client provides the received guest credentials to a server via a communications network. The guest client receives from the server, via the communications network, an identifier associated with the guest account associated with the provided guest credentials. The guest client determines a hotel associated with the guest account. The guest client receives a guest initiated work order via the user interface of the guest client and provides the guests initiated work order to a work order management system associated with the determined hotel via the communications network.

In another aspect, a guest request management system includes a work order management system. The work order management system is configured to receive the guest initiated work order from a guest client via a communications network. The guest initiated work order includes a task and an identifier associated with the guest account. The work order management system pushes the guest initiated work order to at least one client of the work order management system via the communications network. The work order management system receives start notice from a client of the work order management system via the communications network and provides the received start notice to the guest client via the communications network in response to receiving the start notice from the client of the work order management system. The work order management system receives a completion notice from the client of the work order management system and provides the completion notice to the guest client in response to receiving the completion notice from the client of the work order management system.

In another aspect, a guest request management system includes a guest client having user interface, and a work order management system. The guest client is configured to receive guest credentials from a guest via the user interface, and provide the received guest credentials to a server via communications network. The guest client receives from the server, via the communications network, an identifier associated with the guest account associated with the provided guest credentials. The guest client determines a hotel associated with the guest and receives a guest initiated work order via the user interface of the guest client. The work order management system is configured to receive guest initiated work order from the guest client via the communications network. The guest initiated work order includes a task and the identifier associated with the guest account. The work order management system pushes the guests initiated work order to at least one client of the work order management system via the communications network. The work order management system receives a start notice from a client of the work order management system via the communications network and provides the received start notice to the guest client via the communications network in response to receiving the start notice from the client of the work order management system. The work order management system receives a completion notice from the client of the work order management system via the communications network and provides the completion notice to the guest client in response to receiving the completion notice from the client of the work order management system.

### BRIEF DESCRIPTION OF THE SEVERAL VIEWS OF THE DRAWINGS

FIG. 1 is a block diagram of a guest request management system showing a guest client.

FIG. 2 is a block diagram of a guest request management system having a guest account database and hotel position database separate from a work order management system.

FIG. 3 is a block diagram of a guest request management system having a guest account database and hotel position database integrated with a work order management system.

FIG. 4 is a screen capture of a user interface of a guest client configured to receive guest credentials.

FIG. 5 is a screen capture of a user interface of a guest client configured to receive a selection of displayed hotel data.

FIG. 6 is a screen capture of a user interface of a guest client configured to receive a pin to confirm a determined hotel.

FIG. 7 is a screen capture of a user interface of a guest client configured to receive a guest request prior to a room assignment.

FIG. 8 is a screen capture of a user interface of a guest client configured to receive a guest request after a room is assigned to the guest account corresponding of the guest client.

FIG. 9 is a screen capture of a user interface of a guest client configured to receive a guest initiated work order.

FIG. 10 is a screen capture of a user interface of a guest client displaying a status update in response to receiving a start notice at the guest client.

FIG. 11 is a screen capture of a user interface of a guest client displaying a status update in response to receiving a completion notice at the guest client.

FIG. 12 is a screen capture of a user interface of a guest client displaying a prompt for a rating in response to receiving a completion notice at the guest client.

FIG. 13 is a screen capture of a user interface of a guest client displaying a status update in response to receiving a start notice at the guest client.

FIG. 14 is a screen capture of a user interface of a guest client displaying a list of statuses of guest requests made via the guest client during a current visit.

FIG. 15 is a screen capture of a user interface of a guest client displaying details of a completed guest initiated work order.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

The term “when” is used to specify orientation for relative positions of components, not as a temporal limitation of the claims or apparatus described and claimed herein unless otherwise specified.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

In one embodiment, a guest request management system enables hotel guests to directly enter work orders into a hotel's work order management system. In order to prevent the work order management system from being overwhelmed with illegitimate work orders, the guest request management system may be limited to registered guests at a given hotel during their stay at the hotel. Further, certain guest initiated requests (e.g., sundry delivery, towel service, etc.) should be limited to the room assigned to the guest placing the order (i.e., entering the work order into the work order management system of the hotel).

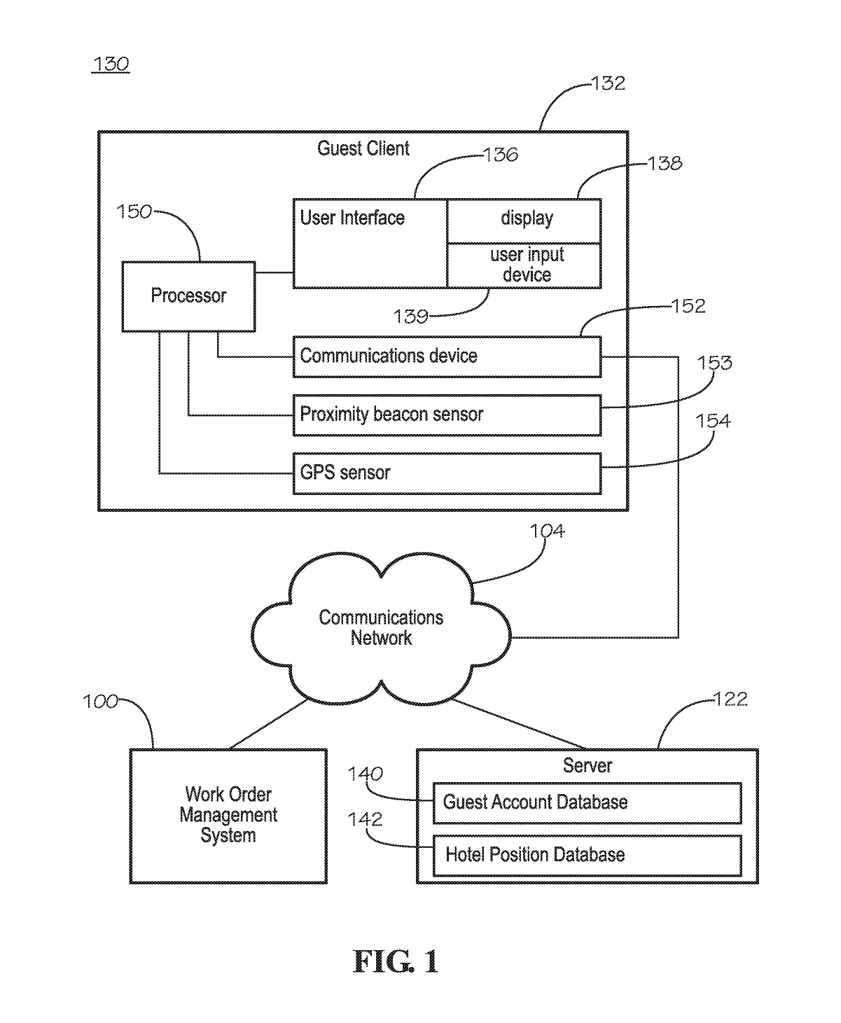

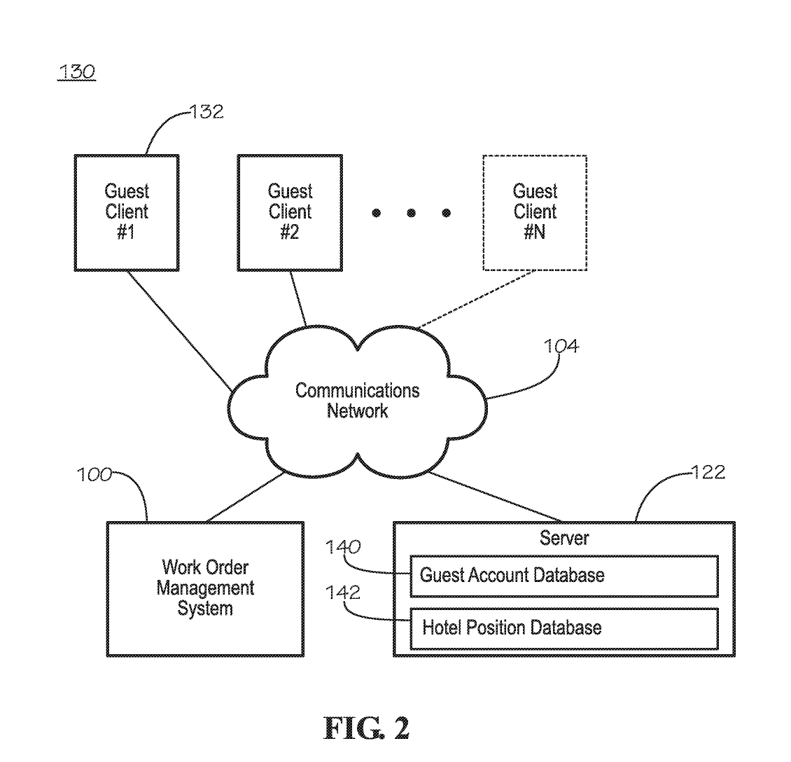

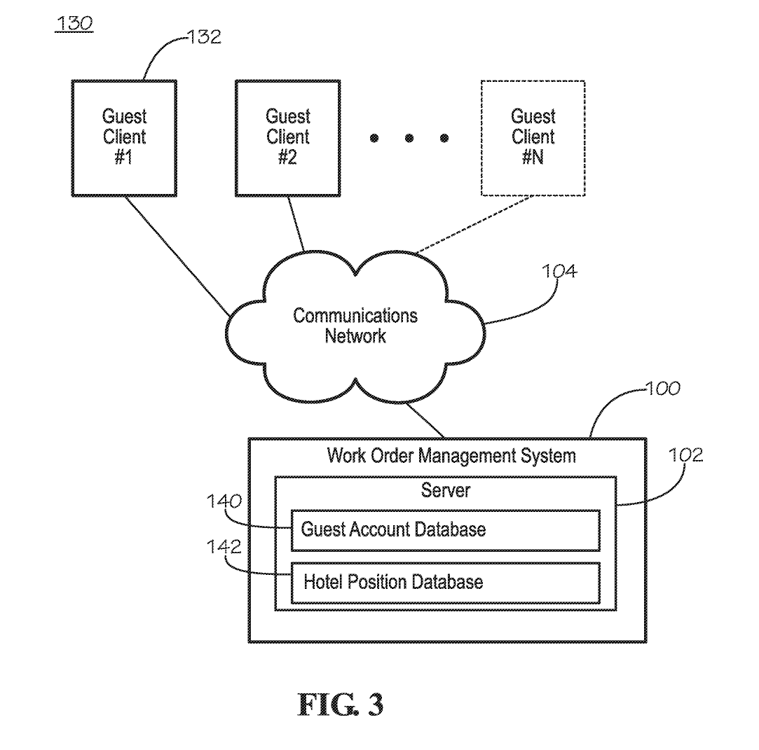

Referring to FIGS. 1 and 2, a guest request management system 130 includes a work order management system 100 and a guest client 132 having user interface 136. In the guest request management system 130 of FIGS. 1 and 2, the server 122 including a hotel position database 142 and guest account database 140 are separation from the work order management system 100. It is contemplated that the work order management system 100 may have a server 102 incorporating both the guest account database 140 and the hotel position database 142. Additionally, the guest request management system 130 may include any number of guest clients.

In one embodiment, the guest client 132 incorporates a mobile computing device. In one embodiment, the mobile computing device includes the user interface 136 formed from the display 138 and the user input device 139, a processor 150, the communications device 152, a proximity sensor 153, and a global positioning satellite (GPS) sensor 154. The processor 150 passes data between components of the mobile computing device as instructed by the guest client 132. The communications device 152 provides data to the communications network 104 and receives data from the communications network 104 which it provides to the processor 150.

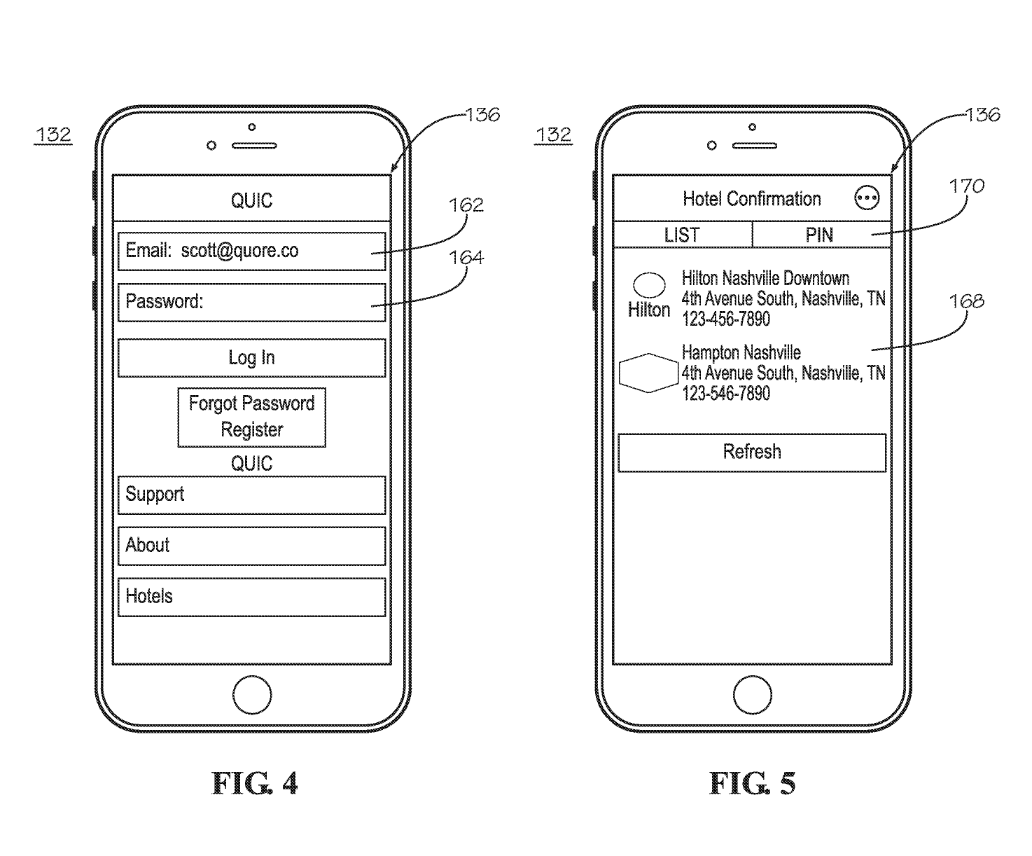

In one embodiment, the user interface 136 is a touchscreen including a display 138 and a user input device 139. Referring to FIG. 4, the guest client 132 is configured to receive guest credentials from a guest via the user interface 136. In one embodiment, the guest credentials include an email address or user name 162 and a password 164. The guest client 132 provides the received guest credentials to the server 122 via a communications network 104. The guest client 132 receives from the server 122 via the communications network 104 an identifier (e.g., token) associated with the guest account associated with the provided guest credentials. In one embodiment, the guest client 132 receives from the server 122 a token in response to providing the guest credentials to the server 122 via the communications network 104. The token includes a token expiration time corresponding to a checkout time of the guest from a given hotel. In one embodiment, the server 122 includes a hotel reservation and registration system that assigns room numbers to guests, and the token provided by the server 122 includes a room assignment. In another embodiment, the server 122 is integrated with the work order management system 100 for the given hotel, and the server 122 communicates directly with the work order management system 100 (i.e., not through the guest client 132) to assign a room to the guest client 132 and provide the token including the room assignment to the guest client 132 from either the server 122 or the work order management system 100. The work order management system 100 associates the identifier associated with the guest account associated with the guest client 132 with the assigned hotel room in the determined hotel for a predetermined period of time, and the token includes the expiration time which corresponds to the predetermined period of time or the checkout time. In another embodiment, the server 122 provides the identifier associated with the guest account to the guest client 132 in response to receiving valid guest credentials form the guest client 132, and the guest client 132 subsequently communicates with the work order management system 100 in order to determine a hotel and get a token including hotel, expiration time, and room assignment.

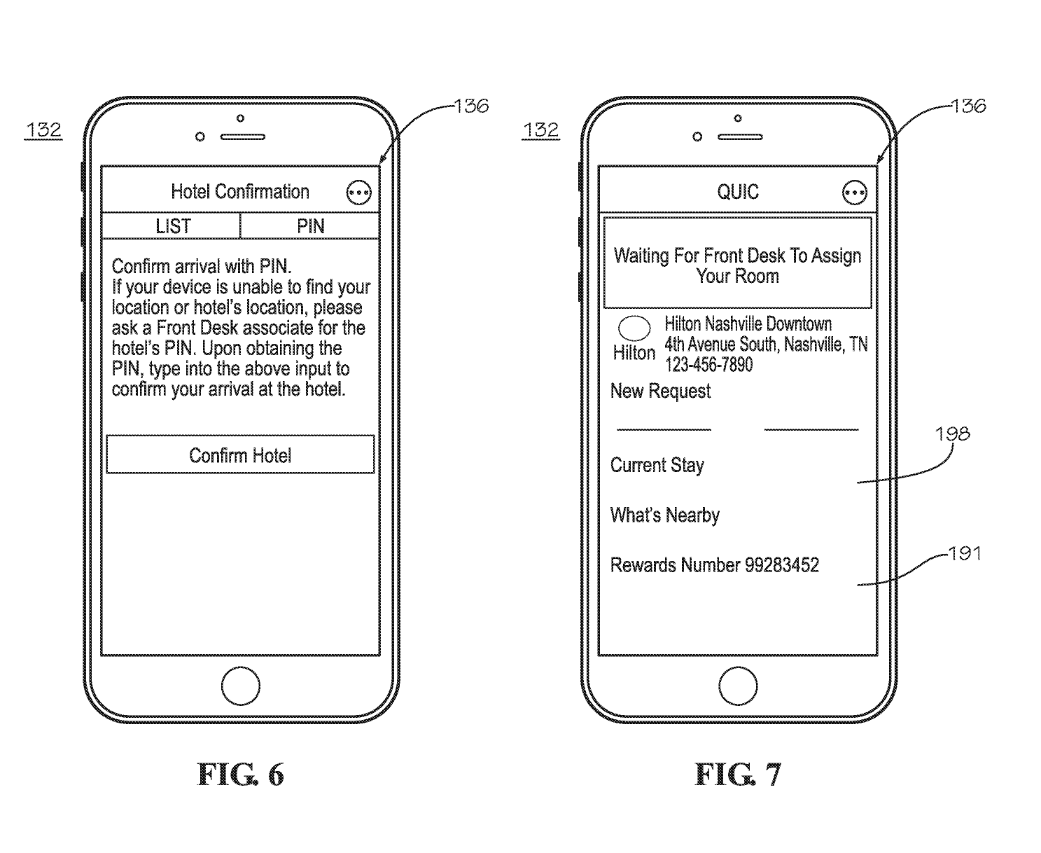

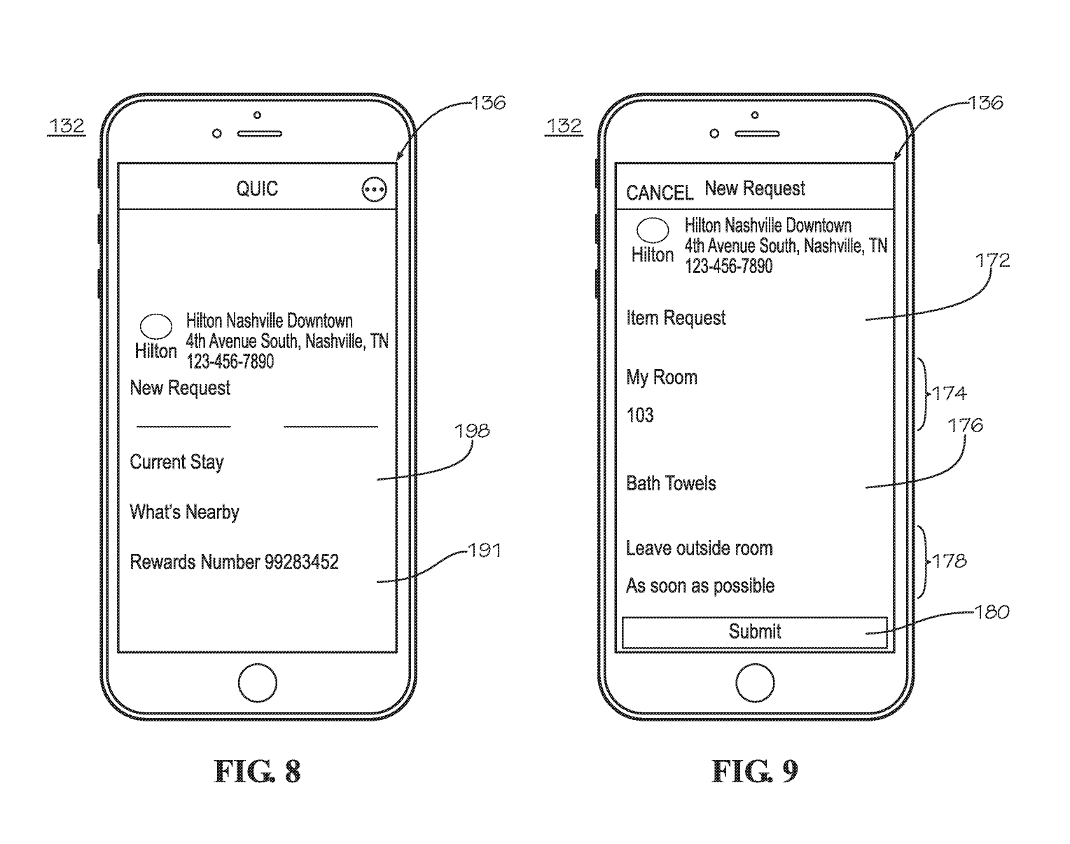

The guest client 132 is configured to determine a hotel associated with the guest account. In one embodiment, the guest client 132 determines the hotel associated with the guest account by receiving hotel data from the server 122 based on reservation data stored in the server 122 in response to providing the guest credentials to the server 122. The proximity sensor 153 of the guest client 132 may be any of a near field communications device, a Bluetooth radio, and IEEE 802.11 standard radio, or another specially proximity sensor (e.g., RFID). The proximity sensor 153 is operable to sense the presence of corresponding Beacon and provide position data representative of location of the mobile computing device of the guest client 132 in response to something the presence of the corresponding beacon. In one embodiment, the proximity sensor 153 is a proximity beacon sensor configured to receive a beacon identifier from a beacon when in range of the beacon. The guest client 132 provides the beacon identifier to the server 122, the server compares the beacon identifier to the hotel position database 142 to determine one or more hotels corresponding to the beacon identifier. The guest client 132 receives from the server 122 hotel data corresponding to a hotel associated with the beacon identifier in the hotel position database 142. In one embodiment, in response to receiving the hotel data, the guest client 132 displays a least a portion of the received hotel data via the user interface 136 (i.e., display 138) (see FIG. 5). In another embodiment, the GPS sensor 154 of the guest client 132 is configured to provide position data representative of a location of the mobile computing device of the guest client 132. The guest client 132 provides the position data received from the GPS sensor 154 to the server 122. The server 122 compares the position data to a hotel position database 142 to determine one or more hotels corresponding to the position data. The guest client 132 receives from the server 122 via the communications network 104 hotel data corresponding to each of the determined one or more hotels. In response to receiving the hotel data corresponding to the one or more hotels, the guest client 132 displays at least a portion of the hotel data for each of the determined one or more hotels via the user interface 136 of the guest client 132. As shown in FIG. 5, the user interface 136 displays first hotel data 166 corresponding to a first hotel near the guest client 132 and second hotel data 168 corresponding to a second hotel near the guest client 132. The guest client 132 is configured to receive a selection of displayed hotel data (e.g., one of the displayed hotels) when the guest client 132 is displaying hotel data for more than one hotel. The guest client 132 provides at least a portion of the hotel data corresponding to the selected displayed hotel data to the server 122 in response to receiving the selection. In one embodiment, when hotel data corresponding to the desired hotel is not show, the guest may select a manual pin entry option 170. The guest can acquire a pin number from hotel staff (e.g., front desk personnel) and enter the pin number into the user interface 136 of the guest client 132 to determine the hotel (see FIG. 6). In one embodiment, the guest client 132 is further configured to prompt the guests via the user interface 136 to provide a rewards program number via the user interface 136 when the server 122 does not provide a rewards program number with the identifier associated with the guest account associated with the guest credentials provided by the guest client 132 and there is no rewards program number stored at the guest client 132 for the determined hotel. The guest enters a rewards number for the determined hotel in a rewards number field 191 of the user interface 136 (see FIGS. 7 and 8), and in response to receiving the rewards program number, the guest client 132 provides the received rewards program number to the server 122 via the communications network 104. The server 122 associates the rewards program number with the guest account in the guest account database 140. Additionally, the guest client 132 may store the rewards program number locally with the identifier of the guest account and hotel data corresponding to the determined hotel or hotel chain of the determined hotel.

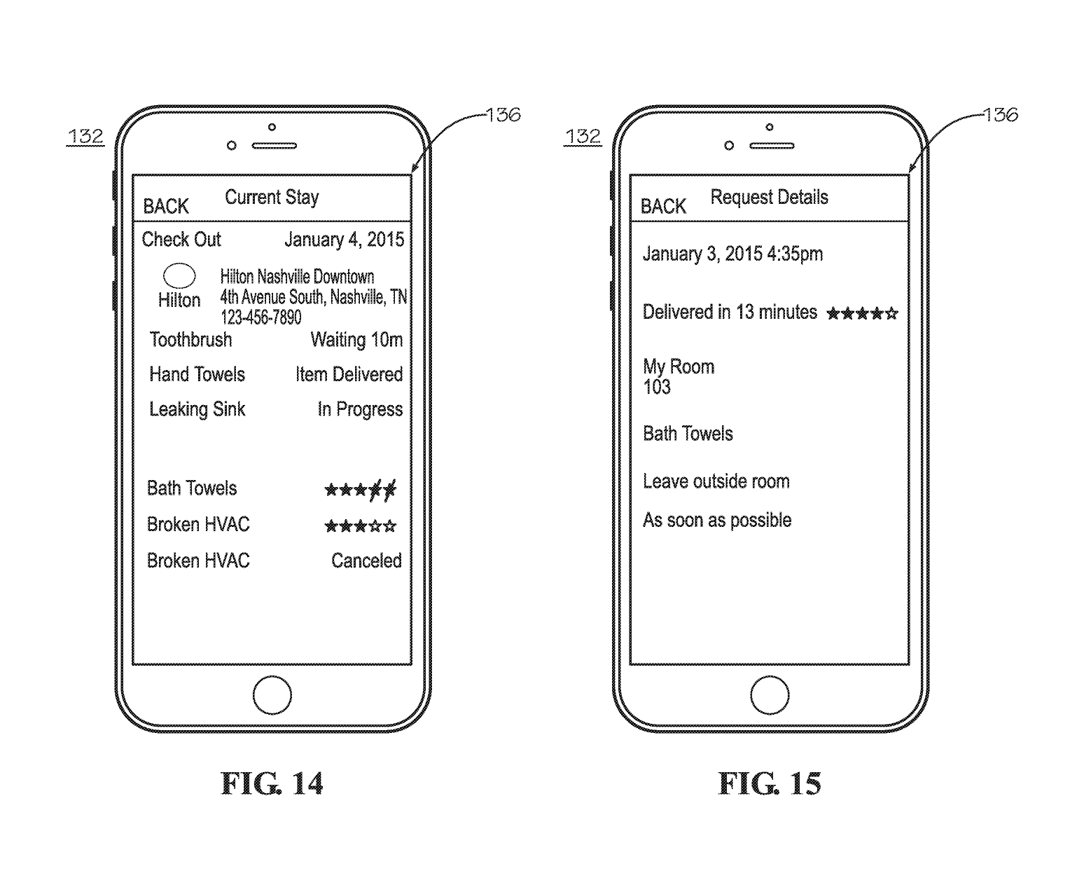

When the guest client 132 logs into the guest request management system (i.e., provides valid guest credentials) and selects a hotel, available functionality of the guest request management system 130 depends on whether the hotel staff or reservation/registration system of the hotel has assigned a room number to the guest account corresponding to the guest and guest client 132. In one embodiment, the guest client 132 determines whether the guest client 132 has an unexpired token corresponding to the determined hotel. Having an unexpired token means that a room has been associated with the guest account corresponding to the guest client 132. The guest client 132 displays list of tasks to the guest the of the user interface 136 of the guest client 132 when the guest client 132 has an unexpired token corresponding to the determined hotel (see FIG. 8). The guest client 132 displays a subset of the list of tasks to the guest via the user interface 136 of the guest client 132 when the guest client does not have an unexpired token corresponding to the determined hotel (see FIG. 7). The tasks in the subset of the list of tasks are not specific to a room of hotel. That is, the subset of tasks relates only to common areas of the hotel and may include tasks such as, for example, providing complimentary beverages or newspapers, valet service, bell service, etc. In one embodiment, along with the list of available requests, the guest client 132 provides alternative actions such as viewing a summary of the current stay at the determined hotel. Referring to FIG. 14, in one embodiment, selecting a current stay button 198 on user interface 136 causes the guest client 132 to display a list of each guest initiated work order initiated by the guest during the current stay together with a status of each of the requests (i.e., guest initiated work orders).

In one embodiment, the subset of the list of tasks is provided by the work order management system 100 corresponding to the determined hotel. In this way, the guest request management system 130 can ensure that the listed tasks include only tasks relevant to the determined hotel. For example, including tasks related to a pool for a hotel that does not have a pool would be confusing to the guest. In another embodiment, the list of tasks is predetermined and stored at the guest client 132. The hotel data received by the guest client 132 for the determined hotel includes hotel parameters (e.g., whether or not the hotel has a pool) used to filter the displayed list of tasks such that the list of task is limited only to tasks appropriate to the determined hotel.

In one embodiment, the guest client 132 displays all available tasks associated with the determined hotel whether the guest associated with the guest client (i.e., logged into the guest client 132) has been assigned a room at the determined hotel or not. Guest initiated work orders directed to non-room-specific tasks may be received and transmitted to the work order management system 100 by the guest client 132 as described above. In response to receiving a room specific task, the guest client 132 provides the received room specific task (i.e., the guest initiated work order) to the work order management system 100, and additionally, provides a request or work order for a room assignment. That is, when the guest client 132 does not have an unexpired token corresponding to the determined hotel and the guest generates a guest initiated work order, the guest client 132 provides a 2^{nd} work order to work order management system 100 including a request for a room assignment for the guest. In one embodiment, the request for the room assignment is sent with high-priority and automatically assigned to the front desk of the determined hotel. Alternatively, the work order management system 100 can receive the guest initiated work order and determine whether the guest client 132 from which the guest initiated work orders received has an associated room number (i.e., and assigned a room number). When the work order management system 100 determines that the guest client 132 from which the guest initiated work orders received is not have an associated room number, the work order management system 100 generates the 2^{nd} work order including a task of assigning a room number to the guest account corresponding to the guest client 132 and sets the priority rating of the 2^{nd} work order as high within the work order management system 100.

Referring to FIG. 9, the guest client 132 is configured to receive a guest initiated work order via the user interface 136 of the guest client 132. In one embodiment, the user interface 136 displays a list of all available tasks and the guest selects one of the displayed tasks via the user interface 136 to generate the guest initiated work order. In one embodiment, a set of filters are progressively applied to the list of tasks by the guest client 132 in order to facilitate the guest finding the guest's desired task. Available filters include request type 172, location 174, item 176, and delivery method 178. The guest completes the guest initiated work order by actuating a submit button 180, and the guest client 132 provides the guest initiated work order to a work order management system 100 associated with the determined hotel via the communications network 104. In one embodiment, the guest initiated work order provided by the guest client to the work order management system 100 includes the selected task and the identifier associated with the guest account (e.g., at least a portion of the token provided to the guest client 132 by the server 122).

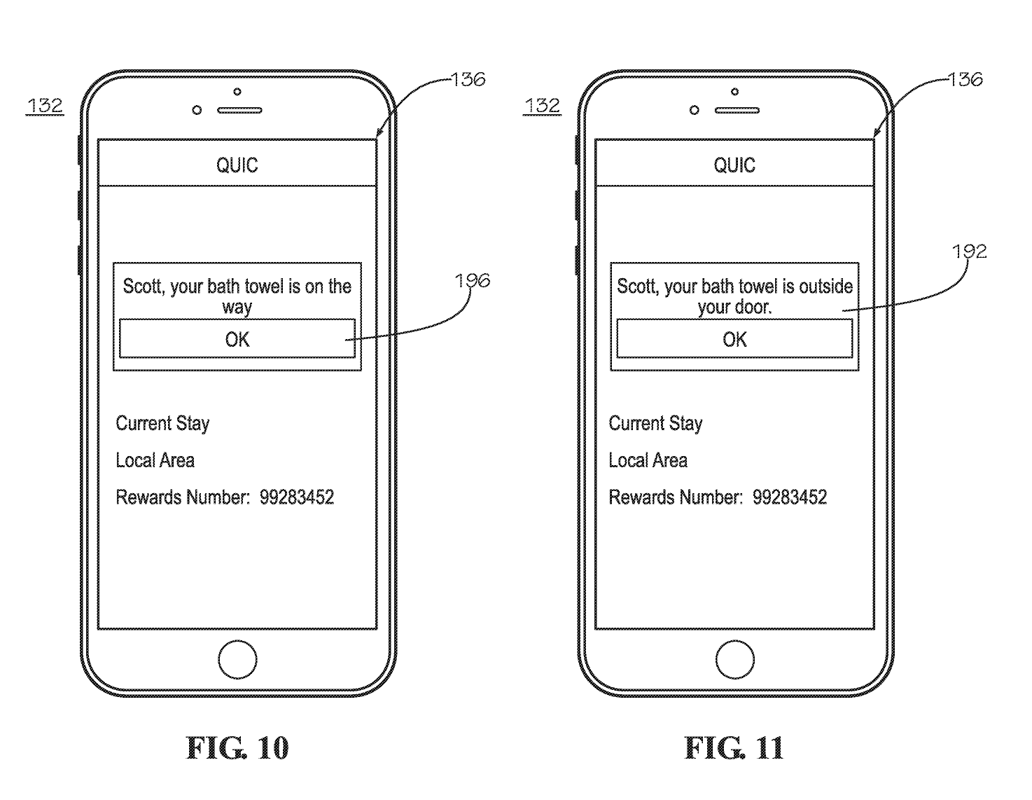

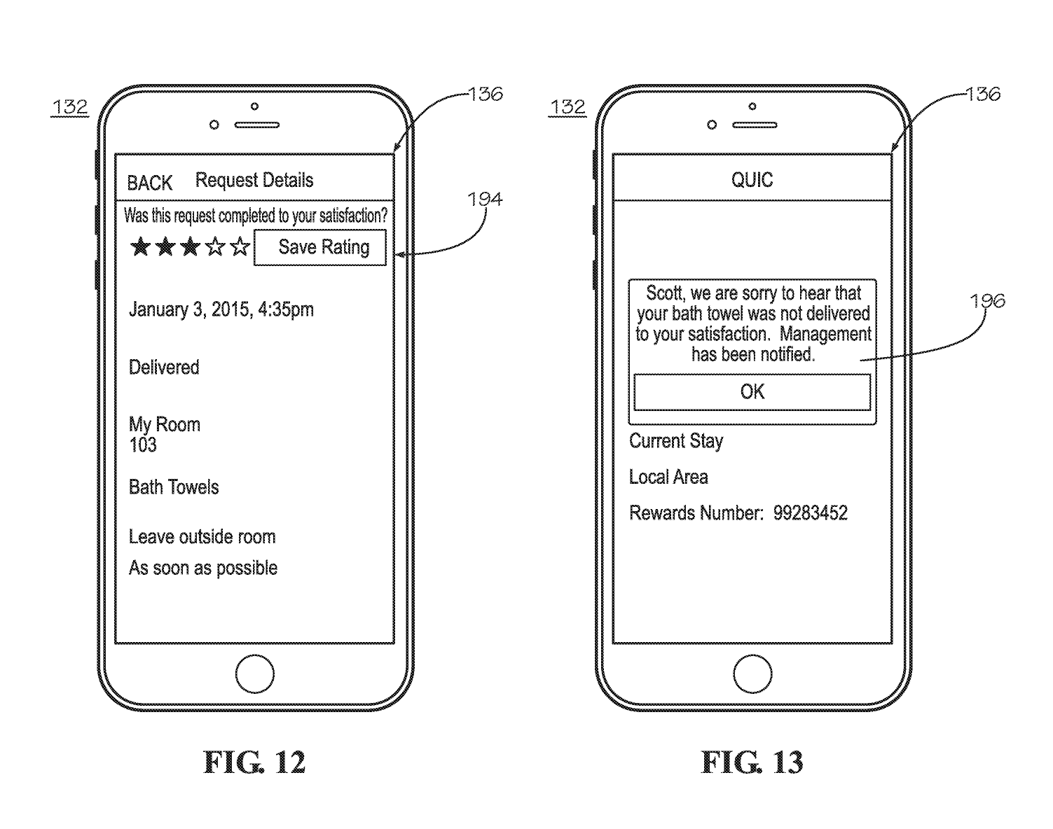

The work order management system 100 is configured to receive the guest initiated work order from the guest client 132 via the communications network 104. The guest initiated work order includes the task and the identifier associated with the guest account (e.g., a unique identifier, a guest account number, or a rewards program number). The work order management system pushes the guest initiated work order to at least one client of the work order management system 100 via the communications network 104. The work order management system 100 subsequently receives a start notice from a client of the work order management system 100 via the communications network 104. The work order management system 100 provides the receive start notice to the guest client 132 via the communications network 104 in response to receiving the start notice from the client of the work order management system 100. In one embodiment, the work order management system 100 pushes such status updates and notices to the guest client 132 via a push messaging service such as Google Messaging or Apple Messaging. Referring to FIG. 10, in response to receiving the start notice from work order management system 100 the guest client 132 displays a status update 190 via the user interface 136 of the guest client 132 to the guest indicating that the selected task represented in the guest initiated work order has been started. When the task is subsequently been completed, the work order management system 100 receives a completion notice from the client of the work order management system 100 via the communications network 104, and provides the received completion notice to the guest client 132 in response to receiving the completion notice. In one embodiment, in response to receiving the completion notice at the work order management system 100, the workers and management system 100 updates and item inventory of an item associated with the task in the completed work order in response to receiving the completion notice from the client of the work order management system 100. That is, for example if the guest initiated work order includes delivering a toothbrush to the room associated with the guest account, the work order management system updates a toothbrush inventory of the determined hotel by deducting a toothbrush from the inventory in response to receiving the completion notice. Referring to FIG. 11, in response to receiving the completion notice from the work order management system 100, the guest client 132 displays a status update 192 via the user interface 136 of the guest client 132 indicating that the task has been completed. When the guest clears the status update 192 corresponding to the completion notice (e.g., presses okay), the guest client 132 displays via the user interface 136 a rating field 194 to the guest (see FIG. 12). The guest enters a rating in the rating field 194, and when the provided rating is less than a predetermined rating (e.g., less than 4 out of 5 stars), the guest client 132 provides a follow-up work order to the work order management system 100. The task of the follow-up work order is contacting the guest associated with the guest account associated with the guest client 132 regarding the unsatisfactory completion of the guest initiated work order (i.e., guest's request). Referring to FIG. 13, in one embodiment, in response to receiving the rating less than the predetermined rating, the guest client 132 displays a status update 196 indicating that the follow-up work order has been provided to the work order management system 100.

It will be understood by those of skill in the art that navigating between user interface views is accomplished by selecting a tab or object in a current user interface view corresponding to another user interface view, and in response to selecting the tab or object, the user interface updates with said another user interface view corresponding to the selected tab or object.

It will be understood by those of skill in the art that providing data to the system or the user interface may be accomplished by clicking (via a mouse or touchpad) on a particular object or area of an object displayed by the user interface, or by touching the displayed object in the case of a touchscreen implementation.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although embodiments of the present invention have been described in detail, it will be understood by those skilled in the art that various modifications can be made therein without departing from the spirit and scope of the invention as set forth in the appended claims.

A controller, processor, computing device, client computing device, client, or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media. As used herein, server is not intended to refer to a single computer or computing device. In implementation, a server will generally include an edge server, a plurality of data servers, a storage database (e.g., a large scale RAID array), and various networking components. It is contemplated that these devices or functions may also be implemented in virtual machines and spread across multiple physical computing devices.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful GUEST INTERFACE FOR GENERATING WORK ORDERS IN A WORK ORDER MANAGEMENT SYSTEM it is not intended that such references be construed as limitations upon the scope of this invention except as set forth in the following claims.

What is claimed is:

1. A guest request management system comprising:
a guest client having a user interface, wherein the guest client is configured to:
receive guest credentials from a guest via the user interface;
provide the received guest credentials to a server via a communications network;
receive, from the server via the communications network, an identifier associated with the guest account associated with the provided guest credentials;
determine a hotel associated with the guest account;
receive a guest initiated work order via the user interface of the guest client; and
provide the guest initiated work order to a work order management system associated with the determined hotel via the communications network.

2. The guest request management system of claim 1, wherein the guest client is further configured to receive a task from the guest via the user interface of the guest client, and the guest initiated work order comprises the task and the identifier associated with the guest account.

3. The guest request management system of claim 1, the guest client comprises a mobile computing device having a global positioning satellite sensor operable to provide position data representative of a location of the mobile computing device;
the guest client is further configured to provide the position data to the server;
the server compares the position data to a hotel position database to determine one or more hotels corresponding to the position data;
the guest client receives from the server via the communications network, hotel data corresponding to each of the determined one or more hotels;
the guest client is further configured to display at least a portion of the hotel data for each of the determined one or more hotels via the user interface of the guest client in response to receiving the hotel data; and
the guest client is further configured to receive a selection of displayed hotel data when the guest client is displaying hotel data for more than one hotel and provide at least a portion of the hotel data corresponding to the selected displayed hotel data to the server in response to receiving the selection.

4. The guest request management system of claim 1, wherein:
the guest client comprises a mobile computing device having a proximity beacon sensor operable to receive a beacon identifier of a beacon when in range of the beacon and;
the guest client is further configured to provide the beacon identifier to the server;
the server compares the beacon identifier to a hotel position database to determine one or more hotels corresponding to the beacon identifier;
the guest client receives from the server via the communications network, hotel data corresponding to a hotel associated with the beacon identifier in the hotel position database; and
the guest client is further configured to display at least a portion of the hotel data for the hotel associated with the beacon identifier in the hotel position database to the guest via the user interface of the guest client in response to receiving the hotel data.

5. The guest request management system of claim 1, wherein the guest client determines the hotel associated with the guest account by receiving hotel data from the server based on reservation data stored in the server in response to providing the guest credentials to the server, wherein the hotel data is indicative of the hotel.

6. The guest request management system of claim 1, wherein the guest client is further configured to prompt the guest via the user interface to provide a rewards program number via the user interface when the server does not provide a rewards program number with the identifier associated with the guest account associated with the guest credentials provided by the guest client; and
the guest client is further configured to receive the rewards program number via the user interface and provide the received rewards program number to the server via the communications network together with the identifier associated with the guest account or an identifier indicative of the guest client in response to receiving the rewards program number via the user interface; and
the server associates the rewards program number received from the guest client with the guest account in a guest account database.

7. The guest request management system of claim 1, wherein:
the guest client receives from the work order management system a token in response to providing the guest credentials to the server via the communications network; and
the token comprises a token expiration time corresponding to a checkout time of the guest from the determined hotel.

8. The guest request management system of claim 1, wherein:
the guest client is configured to determine whether the guest client has an unexpired token corresponding to the determined hotel;
the guest client is further configured to display a list of tasks to the guest via the user interface of the guest client when the guest client has an unexpired token corresponding to the determined hotel;
the guest client is further configured to display a subset of the list of tasks to the guest via the user interface of the guest client when the guest client does not have an unexpired token corresponding to the determined hotel, wherein the tasks in the subset of the list of tasks are not specific to a room of the hotel;
the guest client receives the guest initiated work order via the user interface of the guest client by receiving a selection of a displayed task from the guest via the user interface; and
the guest client is configured to provide the guest initiated work order to the work order management system via the communications network in response to receiving the selection of a displayed task via the user interface of the guest client.

9. The guest request management system of claim 1, wherein:
the guest client is configured to receive a start notice corresponding to the guest initiated work order provided to the work order management system via the communications network from the work order management system via the communications network; and
in response to the start notice, the guest client displays a status update via the user interface of the guest client indicating that the task has been started.

10. The guest request management system of claim 1, wherein:
the guest client is configured to receive a completion notice from the work order management system via the communications network; and
in response to receiving the completion notice, the guest client displays a status update via the user interface of the guest client indicating that the task has been completed.

11. The guest request management system of claim 1, wherein:
the guest client is configured to receive a completion notice from the work order management system via the communications network; and
in response to receiving the completion notice, the guest client displays a status update via the user interface of the guest client indicating that the task has been completed and displays a rating field to the guest via the user interface until the guest provides a rating via the rating field displayed by the user interface, wherein when the provided rating is less than a predetermined rating, the guest client provides a follow up work order to the work order management system, wherein a task of the follow up work order is contacting the guest associated with the guest account associated with the guest client.

12. The guest request management system of claim 1, wherein:
the guest client is further configured to determine whether the guest client has an unexpired token corresponding to the determined hotel;
the guest client is further configured to display a list of tasks to the guest via the user interface of the guest client;
the guest client receives the guest initiated work order via the user interface of the guest client by receiving a selection of a displayed task from the guest via the user interface; and
the guest client is configured to provide in response to receiving the selection of a displayed task via the user interface of the guest client:
the guest initiated work order to the work order management system via the communications network; and
a request for a room assignment when the guest client determines that the guest client does not have an unexpired token corresponding to the determined hotel.

13. A guest request management system comprising:
a work order management system configured to:
receive a guest initiated work order from a guest client via a communications network, wherein the guest initiated work order comprises a task and an identifier associated with the guest account;
push the guest initiated work order to at least one client of the work order management system via the communications network;
receive a start notice from a client of the work order management system via the communications network;
provide the received start notice to the guest client via the communications network in response to receiving the start notice from the client of the work order management system;
receive a completion notice from the client of the work order management system via the communication network; and
provide the completion notice to the guest client in response to receiving the completion notice from the client of the work order management system.

14. The guest request management system of claim 13, wherein the work order management system comprises a server configured to store a guest account database, receive guest credentials from a guest client via the communications network, compare the received credentials to guest accounts in the guest account database to determine the identifier associated with the guest account, and provide the identifier associated with the guest account to the guest client via the communications network.

15. The guest request management system of claim 13, wherein the work order management system determines the identifier associated with the guest account by receiving the identifier associated with the guest account from a server configured to store a guest account database, receive guest credentials from a guest client via the communications network, compare the received credentials to guest accounts in the guest account database to determine the identifier associated with the guest account, and provide the determined identifier associated with the guest account to the work order management system.

16. The guest request management system of claim 13, wherein the work order management system is further configured to determine whether a guest account corresponding to the guest client from which the guest initiated work order is received has an associated room number and generate a second work order if the guest account corresponding to the guest client from which the guest initiated work order is received does not have an associated room number, wherein the second work order comprises a task of assigning a room number to the guest account corresponding to the guest client and a priority rating of the second work order is set as high within the work order management system.

17. The guest request management system of claim 13, wherein the work order management system is further configured to associate the identifier associated with the guest account with a hotel room in the determined hotel for a predetermined period of time and to provide a token comprising an expiration time to the guest client in response to receiving the identifier associated with the guest account at the work order management system.

18. The guest request management system of claim 13, wherein the work order management system is further configured to associate the identifier associated with the guest account with a hotel room in the determined hotel for a predetermined period of time and to provide a token comprising an expiration time and the room number to the guest client in response to receiving the identifier associated with the guest account at the work order management system.

19. The guest request management system of claim 13, wherein the guest initiated work order comprises a task, said task including delivering an item to a room assigned to the guest account associated with the guest client; and the work order management system is further configured to update an item inventory of the item in response to receiving the completion notice from the client of the work order management system.

20. A guest request management system comprising:
a guest client having a user interface, wherein the guest client is configured to:
receive guest credentials from a guest via the user interface;
provide the received guest credentials to a server via a communications network;
receive, from the server via the communications network, an identifier associated with the guest account associated with the provided guest credentials;
determine a hotel associated with the guest account; and
receive a guest initiated work order via the user interface of the guest client; and
a work order management system configured to:
receive the guest initiated work order from the guest client via the communications network, wherein the guest initiated work order comprises a task and the identifier associated with the guest account;
push the guest initiated work order to at least one client of the work order management system via the communications network;
receive a start notice from a client of the work order management system via the communications network;
provide the received start notice to the guest client via the communications network in response to receiving the start notice from the client of the work order management system;
receive a completion notice from the client of the work order management system via the communication network; and
provide the completion notice to the guest client in response to receiving the completion notice from the client of the work order management system.
